(19) United States
(12) Patent Application Publication
(10) Pub. No.: US 2018/0128095 A1
(43) Pub. Date: May 10, 2018

(54) ESTIMATING DEFORMATION OF A COMPLETION STRING CAUSED BY AN ECCENTRIC TOOL COUPLED THERETO

(71) Applicant: HALLIBURTON ENERGY SERVICES, INC., Houston, TX (US)

(72) Inventors: Yuan ZHANG, Missouri City, TX (US); Robello SAMUEL, Cypress, TX (US)

(73) Assignee: HALLIBURTON ENERGY SERVICES, INC., Houston, TX (US)

(21) Appl. No.: 15/573,572

(22) PCT Filed: Jun. 5, 2015
(86) PCT No.: PCT/US15/34389

§ 371 Date: Nov. 13, 2017

(51) Int. Cl. E21B 47/00; E21B 17/10; E21B 33/14; E21B 47/024; E21B 47/09

(52) U.S. Cl. CPC E21B 47/0006; E21B 17/1035; G01V 9/007; E21B 47/024; E21B 47/09; E21B 33/146

(57) ABSTRACT

A method for estimating the deformation or deformed shape of a portion of a completion string disposed in a portion of a wellbore lined with one or more casings and having one or more tools coupled thereto according to one of: (A) the tools include one or more concentric tools and one or more eccentric tools and the portion of the wellbore is not deviated; (B) the tools include two or more eccentric tools and the portion of the wellbore is not deviated; or (C) the tools include (1) one or more concentric tools, (2) one or more eccentric tools, or both (1) and (2) and the portion of the wellbore is deviated may involve calculating shapes for the completion string where at least one of the tools engages a casing; calculating a deformation energy of the shapes; and selecting a minimal energy shape from the shapes.

### BACKGROUND

The present application relates to estimating deformation of a completion string caused by an eccentric tool coupled thereto.

Wellbores for use in oil and gas exploration and production are often drilled in stages where a first stage is drilled and lined with a casing, then a second, smaller diameter stage is drilled and lined with a casing, and so on. Once drilling of the wellbore is finished, the wellbore completion operations are then undertaken. Completion operations generally refer to the events necessary to bring a wellbore into production once drilling operations have concluded. For example, completion operations may be performed with a completion string having tools coupled thereto (e.g., packers, side pocket mandrels, perforation guns, and the like) that provide for enablement of safe and efficient production from an oil or gas well.

With increasingly complex wellbore geometries in both diameter and trajectory, advanced completion tools are often run into the wellbore together to maximize reservoir productivity. Due to their design requirements, some tools coupled to the completion string are not concentric with the wellbore but are off-centered or eccentric. These eccentric tools help enhance production and serve multiple purposes. However, because the completion string is rotated as it is run into the wellbore, the eccentric tools coupled thereto add additional radial stress to the completion string and may cause the completion string to deform (e.g. bend). Moreover, eccentric tools frequently become stuck in wellbores, especially small diameter portions of the wellbores, because of this completion string deformation.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates a deformed completion string disposed in a wellbore lined with a casing.

FIG. 2 illustrates an undeformed completion string disposed in a wellbore lined with one or more casings.

FIG. 3 illustrates another example of an undeformed completion string disposed in a wellbore lined with one or more casings.

FIG. 4 illustrates an undeformed completion string disposed in a wellbore, the illustrated portion of which is deviated and lined with one or more casings.

FIG. 5 provides an exemplary illustration of a system for completing an oil and gas well from an offshore platform.

FIG. 6 illustrates a completion string that was modeled and used in two simulated wellbore examples.

FIG. 7 illustrates a cross-sectional diagram of an eccentric tool in a casing.

FIG. 8 shows deformation curves of the completion string at the eccentric tool when the eccentricity varies.

FIG. 9 shows the plot for side forces on components for different eccentricity values.

FIG. 10 shows deflection curves of the completion string at the eccentric tool when the outer diameter (OD) of two concentric tools is varied.

FIG. 11 shows the drag force and energy index for the completion string at the eccentric tool when the OD of two concentric tools is varied.

### DETAILED DESCRIPTION

The methods and analyses described herein estimate the deformation of a completion string, which may then be used to calculate side forces on the completion string. The calculated side forces may be used by engineers and operators to adjust operational parameters when moving the completion string axially and/or rotationally within a wellbore to mitigate the potential of getting the completion string stuck in the wellbore.

In a non-deformed configuration, the completion string is a continuous, substantially straight steel pipe with one or more downhole tools coupled thereto. Concentric tools coupled to the completion string exert equal radial forces on the completion string as it rotates, so the completion string is substantially undeformed. However, eccentric tools exert uneven radial forces and cause the completion string to deform. Additionally, a completion string may deform when the trajectory of the wellbore changes whether one or multiple tools are coupled thereto.

When the completion string deforms, the pipe bends into a wave-like shape such that the tools coupled thereto may (1) engage the casing wall and (2) act as side supports to the deformed completion string. Once the completion string deforms, the shape of the completion string is not constant. Rather, shape changes may occur throughout the wellbore depending on the trajectory and diameter of the wellbore. For example, as the wellbore changes diameter the tools coupled to the completion string are confined to a smaller radial dimension, which causes the shape of the completion string to change.

The methods and analyses described herein use a minimal energy model to determine or estimate the deformed shape of the completion string. The minimal energy model presupposes that the completion string stays in the minimal energy status. After comparing the deformation energy of thousands of possible shapes, the model selects the minimal energy shape (i.e., the shape with the minimum deformation energy). The minimal energy shape may be used when calculating the side forces of the completion string using a continuous string model. Further, the minimal energy model described herein may be used for determining the appropriate distances between tools coupled to the completion string so as to mitigate stuck completion strings and completion string damage.

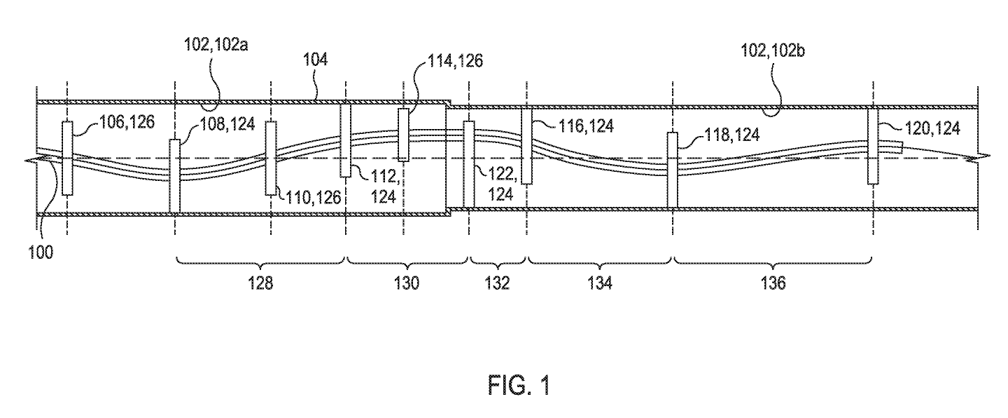

FIG. 1 illustrates a deformed completion string 100 disposed in a wellbore 102 lined with one or more casings 104. The wellbore 102 and casing 104 have two sections: a first section 102a lined with a larger diameter casing than the second section 102b. Further, the illustrated completion string 100 has several tools coupled thereto including concentric tools 106-120 and an eccentric tool 122.

In the minimal energy model described herein, some of the tools 106-122 may be active, meaning the tool engages the casing 104 and supports the completion string 100. In the shape illustrated in FIG. 1, the second, fourth, sixth, seventh, and eighth concentric tools 108,112, 116,118,120, respectively, from left to right are active tools 124 while the other concentric tools 106,110,114 are inactive tools 126 that do not engage the casing wall. Further, the eccentric tool 122 is illustrated as an active tool 124. While FIG. 1 specifically illustrates six active tools 124, including the eccentric tool 122 any number of active tools 124 may be used when calculating the plurality of possible shapes.

The minimal energy model described herein first calculates a plurality of possible shapes that the completion string 100 may assume by varying which tools 106-120 are active tools 124 and inactive tools 126. For example, in some instances, calculating the plurality of possible shapes for the completion string 100 may involve first radially positioning some of the tools 106-120 in the wellbore 102 to be the active tools 124 that engage the casing 104. Then, the completion string 100 shape may be calculated by appropriately connecting the active tools 124. Finally, the remaining tools 106-120 that have been designated inactive tools 126 may be placed along the completion string 100 in their respective axial positions. Once a plurality of shapes has been calculated, the impossible shapes may be eliminated. Impossible shapes for the completion string 100 may arise when the inactive tools 126 are placed back on the completion string 100 and a portion of an individual inactive tool 126 is radially outside the boundary defined by the casing 104.

The deformation energy of each of the remaining possible shapes for the completion string 100 may then be calculated. In some embodiments, the deformation energy of each shape may be calculated by first dividing the completion string 100 into sections 128-136 with endpoints at consecutive active tools 124. Then, the deformation energy for each section 128-136 may be calculated (e.g., according to Equation 1 below, where M is the moment in the section 128-136 of the completion string 100 being calculated, M̅ is the unit moment of the section 128-136 of the completion string 100 being calculated, L is the length of the section 128-136 completion string 100 being calculated, E is Young's modulus of the completion string 100, I is moment of inertia, θ_{A} is the bend angle of the completion string 100 at the first active tool 124 endpoint, θ_{B} is the bend angle of the completion string 100 at the second active tool 124 endpoint, v_{A} is the deflection of the completion string 100 at the first active tool 124 endpoint, and v_{B} is the deflection of the completion string 100 at the second active tool 124 endpoint).

$$U = \frac{EI}{2} \int {k}^{2} dL = \frac{2 EI}{L} [ {θ}_{A}^{2} + {θ}_{A} {θ}_{B} + {θ}_{B}^{2} - 3 ( {θ}_{A} + {θ}_{B} ) \frac{{v}_{B} - {v}_{A}}{L} + \frac{3}{{L}^{2}} {( {v}_{B} - {v}_{A} )}^{2} ] \qquad Equation 1$$

Once the deformation energy for each section 128-136 is calculated, the shape that provides for the lowest total deformation energy (also referred to as the “minimal energy shape”) is selected to represent the real shape of the completion string 100.

In the above discussion and illustrated example, six active tools 124 are used to create five sections 128-136 for determining the possible shapes and the minimal energy shape. While this may be preferred in some instances, any number of active tools 124 and, consequently, any number of sections 128-136 may be used in calculating the possible shapes that the completion string 100 may assume and the minimal energy shape.

The minimal energy shape, as determined by the method described herein or by other methods, may then be further analyzed. For example, the side forces and stresses of the minimal energy shape may be calculated.

For example, a completion string 100 can be equated to a continuous beam supported by the active tools 124 coupled thereto. Accordingly, a continuous beam theory may be used for calculating possible shapes and then, a continuous string model may be used to calculate the bend angles and side forces of each possible shape to arrive at a minimal energy shape.

The side forces and stresses may be useful in predicting if the tool will become stuck in the wellbore. The side forces and stresses may then be used to calculate the drag force and the stress on the completion string 100 (e.g., as described in PCT Patent Application No. PCT/US2013/061683) during axial and/or rotational movement of the completion string within the wellbore.

In some instances, the methods and analyses described herein may be performed during at least a portion of a completion operation (e.g., during axial and/or rotational movement of the completion string within the wellbore). For example, the side forces, drag forces, stresses, or a combination thereof may be analyzed continuously during axial and/or rotational movement of the completion string, at predetermined times during axial and/or rotational movement of the completion string, on-demand, or any combination thereof.

In some instances, the side forces, drag forces, stresses, or a combination thereof calculated by the methods and analyses described herein may be used to determine when completion string 100 failure is possible or likely. For example, threshold values for the side forces, drag forces, stresses, or a combination thereof may be assigned or determined based on the material properties of the completion string 100 and/or tools 106-122 coupled thereto. When the threshold value is reached or approached, actions may be taken to mitigate completion string 100 failure. For example, the axial movement speed and/or the rotational speed may be adjusted to reduce the side forces, drag forces, stresses, or a combination thereof.

The methods and analyses described herein may be applied to a variety of other systems that include at least one eccentric component and optionally one or more concentric components.

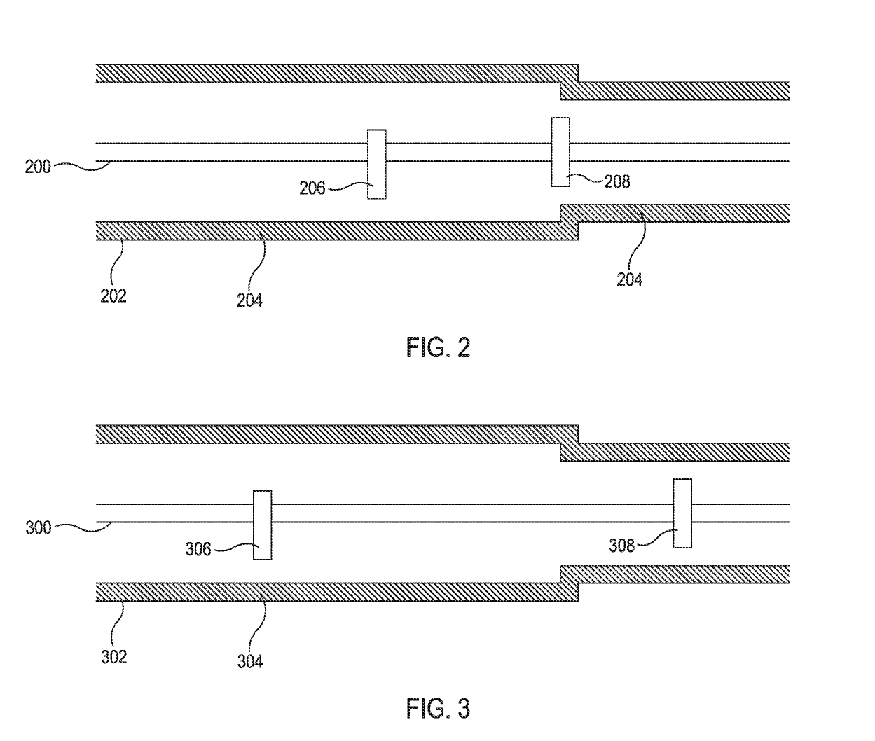

FIG. 2, for example, illustrates a portion of an undeformed completion string 200 disposed or residing in a portion of a wellbore 202 lined with one or more casings 204 (illustrated as two casings 204 with different diameters). The undeformed completion string 200 has an eccentric tool 206 and a concentric tool 208 coupled thereto, to which the methods and analyses described herein may be applied. In such instances, as the methods and analyses are applied, the eccentric tool 206, the concentric tool 208, and optionally portions of the then deformed completion string may be active and engage the casing 204. That is, within the plurality of possible shapes of the deformed completion string may include shapes where only the eccentric tool 206 and the concentric tool 208 are active and shapes were the eccentric tool 206, the concentric tool 208, and one or more portions of the completion string are active (i.e., engaging the casing 204). Then, after the impossible shapes have been eliminated, the deformation energy of each of the remaining possible shapes for the deformed completion string may then be calculated to determine the minimal energy shape and calculate the corresponding side forces, drag forces, stresses, or a combination thereof.

FIG. 3 illustrates a portion of an undeformed completion string 300 disposed or residing in a portion of a wellbore 302 lined with one or more casings 304 (illustrated as two casings 304 with different diameters). The undeformed completion string 300 has two eccentric tools 306,308 coupled thereto, to which the methods and analyses described herein may be applied. In such instances, as the methods and analyses are applied, the eccentric tools 306,308 and optionally portions of the then deformed completion string may be active and engage the casing 304.

As described previously, the methods and analyses described herein may be applied not only to portions of the wellbore with a constant diameter and portions of the wellbore where the diameter changes, but also wellbore trajectory changes (also referred to herein as a deviated portion of the wellbore). When applying the methods and analyses described herein to a portion of the completion string in a deviated portion of the wellbore, the portion of the completion string may have one or more tools coupled thereto where the one or more tools may include (A) one or more eccentric tools, (B) one or more concentric tools, or (C) both (A) and (B).

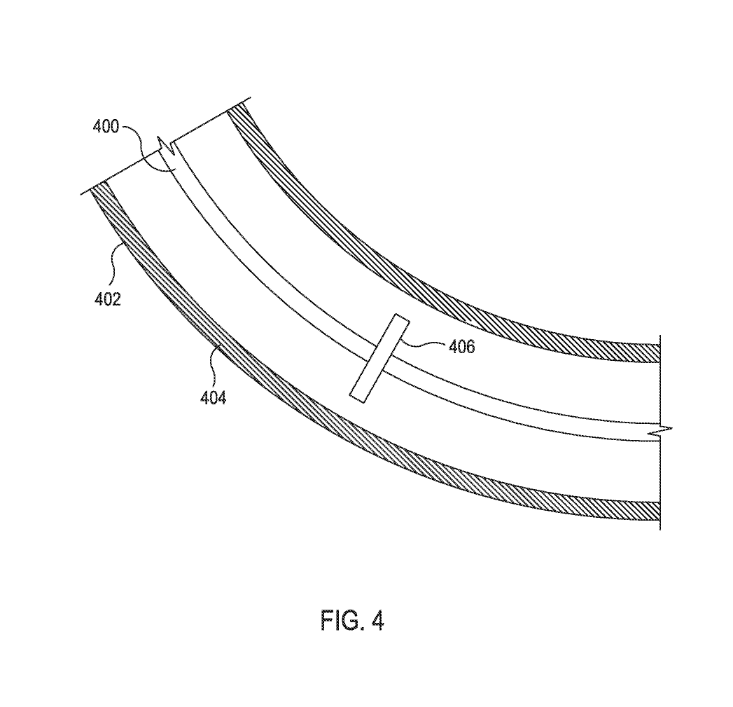

FIG. 4, for example, illustrates an undeformed completion string 400 disposed in a wellbore 402, the illustrated portion of which is deviated and lined with one or more casings 404. The undeformed completion string 400 has coupled thereto a concentric tool 406. The methods and analyses described herein may be applied to the completion string configuration illustrated.

Accordingly, the methods and analyses described herein may be applied to a portion of the wellbore that is lined with one or more casings, wherein a portion of the completion string that resides in the portion of the wellbore has one or more tools coupled thereto according to one of: (A) wherein the one or more tools includes one or more concentric tools and one or more eccentric tools and wherein the portion of the wellbore is not deviated; (B) wherein the one or more tools includes two or more eccentric tools and wherein the portion of the wellbore is not deviated; or (C) wherein the one or more tools includes (1) one or more concentric tools, (2) one or more eccentric tools, or (3) both (1) and (2) and wherein the portion of the wellbore is deviated. In some instances, the portion of the wellbore may change diameter.

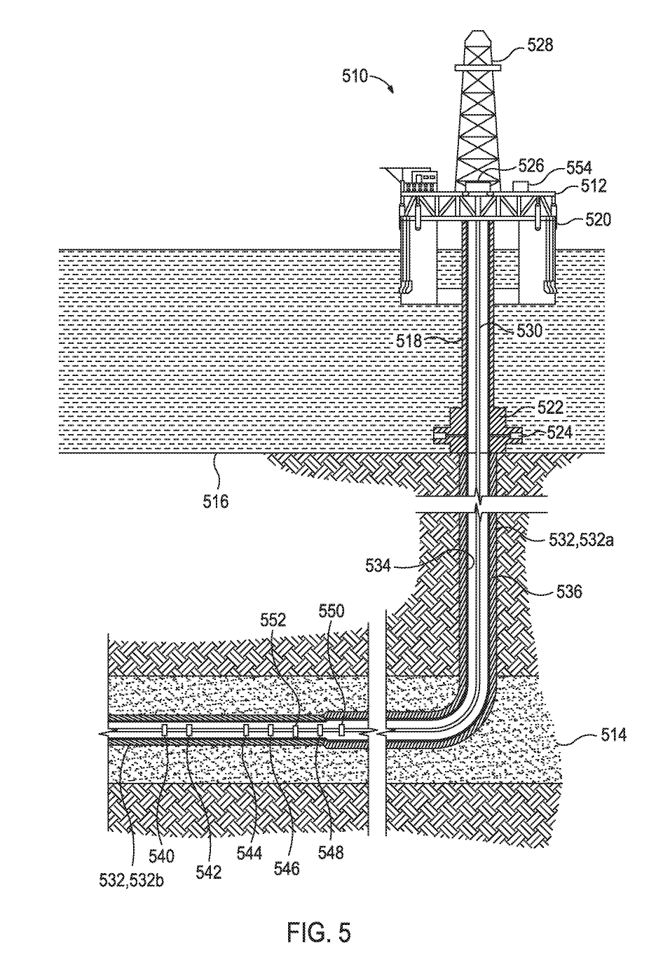

FIG. 5 provides an exemplary illustration of a well system 510 for completing an oil and gas well from an offshore platform 512. While this example is illustrated as an offshore-based well system 510, those skilled in the art will recognize the applicability and corresponding modification for land-based well systems, without departing from the scope of the disclosure.

As illustrated, a semi-submersible platform 512 is centered over a submerged oil and gas formation 514 located below sea floor 516. A subsea conduit 518 extends from a deck 520 of the platform 512 to a wellhead installation 522 including subsea blow-out preventers 524. The platform 512 has a hoisting apparatus 526 and a derrick 528 for raising and lowering pipe strings such as a completion string 530.

A wellbore 532 extends through the various earth strata including the formation 514. As illustrated, a casing 534 lines wellbore 532 and is held in place by cement 536. Further, the wellbore 532 has two sections: a first section 532a with a larger diameter than the second section 532b.

The illustrated completion string 530 includes various tools including six concentric tools 540-550 and one eccentric tool 552. In a completion operation, the completion string 530 is lowered through casing 534 in a downhole direction until properly positioned relative to formation 514. After a completion operation or portion thereof is completed, the completion string 530 may be raised through casing 534 in an uphole direction. During the downhole and uphole axial movements of the completion string 530, the completion string 530 is typically rotated about the longitudinal axis of the wellbore 532, which may cause the completion string 530 to deform because of the eccentric tool 552 coupled thereto.

The illustrated system 510 further includes a control system 554 that may, inter alia, perform the analyses and methods described herein. For example, the control system 554 may receive information regarding the geometry of the wellbore 532 (e.g., the axial depth at which the wellbore 532 transitions from the first section 532a to the smaller diameter second section 532b, the diameter of each of the sections 532a,532b of the wellbore 532, the trajectory of the wellbore 532, and the like), the axial depth of one or more of the tools 540-552, the configuration of the tools 540-552 along the completion string 530 (e.g., the axial spacing of the tools 540-552), the rotational and axial movement speed of the completion string 530, and the like, and any combination thereof. The control system 554 may include a computer-readable medium that stores instructions and corresponding algorithms that may be executed by a processor to executing the methods and analyses described herein. Further, the control system 554 may be configured to alert an operator, cease the axial and/or rotational translation of the completion string 530 within the wellbore 532, change parameters of the axial and/or rotational translation of the completion string 530, or a combination thereof when the side forces, drag forces, stresses, or a combination thereof relative to the completion string 532 are close to or exceed the predetermined threshold values described herein.

The methods and analyses described herein may, in some embodiments, be used when designing or planning a completion operation. For example, when axial and/or rotational movement of the completion string 532 is simulated (e.g., using mathematical models stored and executed on a control system), the minimal energy shape and corresponding side forces, drag forces, stresses, or a combination thereof may be calculated and analyzed. If, during the simulation, the side forces, drag forces, stresses, or a combination thereof indicate that the completion string may fail or become stuck in the wellbore, the completion string 532 design including the tools coupled thereto may be altered. For example, the distance between the individual tools may be altered. In another example, the size and shape of the individual tools may be altered (e.g., a different model of tool may be used that has different dimensions including having more or less eccentricity for the eccentric tool). In yet another example, the parameters of the axial and/or rotational movement of the completion string 532 may be altered (e.g., axial and rotational speeds of the completion string). A combination of the foregoing may also be implemented.

The control system(s) 554 (e.g., used at a well site or in simulating a completion operation) and corresponding computer hardware used to implement the various illustrative blocks, modules, elements, components, methods, and algorithms described herein can include a processor configured to execute one or more sequences of instructions, programming stances, or code stored on a non-transitory, computer-readable medium. The processor can be, for example, a general purpose microprocessor, a microcontroller, a digital signal processor, an application specific integrated circuit, a field programmable gate array, a programmable logic device, a controller, a state machine, a gated logic, discrete hardware components, an artificial neural network, or any like suitable entity that can perform calculations or other manipulations of data. In some embodiments, computer hardware can further include elements such as, for example, a memory (e.g., random access memory (RAM), flash memory, read only memory (ROM), programmable read only memory (PROM), erasable programmable read only memory (EPROM)), registers, hard disks, removable disks, CD-ROMS, DVDs, or any other like suitable storage device or medium.

Executable sequences described herein can be implemented with one or more sequences of code contained in a memory. In some embodiments, such code can be read into the memory from another machine-readable medium. Execution of the sequences of instructions contained in the memory can cause a processor to perform the process steps described herein. One or more processors in a multi-processing arrangement can also be employed to execute instruction sequences in the memory. In addition, hard-wired circuitry can be used in place of or in combination with software instructions to implement various embodiments described herein. Thus, the present embodiments are not limited to any specific combination of hardware and/or software.

As used herein, a machine-readable medium will refer to any medium that directly or indirectly provides instructions to a processor for execution. A machine-readable medium can take on many forms including, for example, non-volatile media, volatile media, and transmission media. Non-volatile media can include, for example, optical and magnetic disks. Volatile media can include, for example, dynamic memory. Transmission media can include, for example, coaxial cables, wire, fiber optics, and wires that form a bus. Common forms of machine-readable media can include, for example, floppy disks, flexible disks, hard disks, magnetic tapes, other like magnetic media, CD-ROMs, DVDs, other like optical media, punch cards, paper tapes and like physical media with patterned holes, RAM, ROM, PROM, EPROM and flash EPROM.

For example, the control system(s) 554 described herein may be configured for receiving inputs, which may be real or simulated data, that may include, but are not limited to, the geometry of the wellbore, the axial depth of one or more of the tools coupled to the completion string, the configuration of the tools along the completion string, the rotational and axial movement speed of the completion string, and the like, and any combination thereof. The processor may also be configured to determine the minimal energy shape of the completion string and calculate the side forces, drag forces, stresses, or a combination thereof corresponding to the minimal energy shape. The output relating to the side forces, drag forces, stresses, or a combination thereof may be a numerical value indicative thereof, a pictorial representation of the minimal energy shape with indicators relating to the side forces, drag forces, stresses, or a combination thereof (e.g., numbers or a color-coded representation that relates color or color intensity to the value thereof), or the like. In some instances, the processor may be further configured for providing an alarm or taking remedial actions when the side forces, drag forces, stresses, or a combination thereof approach or exceed threshold values.

Embodiments disclosed herein include:

Embodiment A: a method that includes introducing a completion string into a wellbore, wherein a portion of the wellbore is lined with the one or more casings and a portion of the completion string that resides in the portion of the wellbore has one or more tools coupled thereto according to one of: (A) wherein the one or more tools includes one or more concentric tools and one or more eccentric tools and wherein the portion of the wellbore is not deviated; (B) wherein the one or more tools includes two or more eccentric tools and wherein the portion of the wellbore is not deviated; or (C) wherein the one or more tools includes (1) one or more concentric tools, (2) one or more eccentric tools, or both (1) and (2) and wherein the portion of the wellbore is deviated; calculating a plurality of shapes for the completion string where at least one of the one or more tools and optionally a portion of the completion string engage a casing of the one or more casings; calculating a deformation energy of at least some of the plurality of shapes; and selecting a minimal energy shape having a lowest deformation energy from the at least some of the plurality of shapes;

Embodiment B: a method that includes simulating with a mathematical model a completion string disposed in a wellbore, wherein a portion of the wellbore is lined with one or more casings and a portion of the completion string that resides in the portion of the wellbore has one or more tools coupled thereto according to one of: (A) wherein the one or more tools includes one or more concentric tools and one or more eccentric tools and wherein the portion of the wellbore is not deviated; (B) wherein the one or more tools includes two or more eccentric tools and wherein the portion of the wellbore is not deviated; or (C) wherein the one or more tools includes (1) one or more concentric tools, (2) one or more eccentric tools, or both (1) and (2) and wherein the portion of the wellbore is deviated, wherein the mathematical model is stored in a non-transitory medium readable by a processor for execution by the processor; simulating movement of the completion string axially and rotationally through the wellbore; calculating a plurality of shapes for the completion string where the eccentric tool and optionally a portion of the completion string engage a casing of the one or more casings; calculating a deformation energy of at least some of the plurality of shapes; and selecting a minimal energy shape having a lowest deformation energy from the at least some of the plurality of shapes;

Embodiment C: a system that includes a completion string extending into a wellbore, wherein a portion of the wellbore is lined with one or more casings and a portion of the completion string that resides in the portion of the wellbore has one or more tools coupled thereto according to one of: (A) wherein the one or more tools includes one or more concentric tools and one or more eccentric tools and wherein the portion of the wellbore is not deviated; (B) wherein the one or more tools includes two or more eccentric tools and wherein the portion of the wellbore is not deviated; or (C) wherein the one or more tools includes (1) one or more concentric tools, (2) one or more eccentric tools, or both (1) and (2) and wherein the portion of the wellbore is deviated; a control system that includes a non-transitory medium readable by a processor and storing instructions for execution by the processor for performing a method comprising: calculating a plurality of shapes for the completion string where the eccentric tool and optionally a portion of the completion string engage a casing of the one or more casings; calculating a deformation energy of at least some of the plurality of shapes; and selecting a minimal energy shape having a lowest deformation energy from the at least some of the plurality of shapes; and

Embodiment D: a non-transitory medium readable by a processor and storing instructions for execution by the processor for performing a method comprising: receiving a plurality of inputs relating to a configuration of a system that comprises a completion string extending into a wellbore, wherein a portion of the wellbore is lined with one or more casings and a portion of the completion string that resides in the portion of the wellbore has one or more tools coupled thereto according to one of: (A) wherein the one or more tools includes one or more concentric tools and one or more eccentric tools and wherein the portion of the wellbore is not deviated; (B) wherein the one or more tools includes two or more eccentric tools and wherein the portion of the wellbore is not deviated; or (C) wherein the one or more tools includes (1) one or more concentric tools, (2) one or more eccentric tools, or both (1) and (2) and wherein the portion of the wellbore is deviated; calculating a plurality of shapes for the completion string where the eccentric tool and optionally a portion of the completion string engage a casing of the one or more casings; calculating a deformation energy of at least some of the plurality of shapes; and selecting a minimal energy shape having a lowest deformation energy from the at least some of the plurality of shapes.

Each of Embodiments A, B, C, and D may have one or more of the following additional elements in any combination: Element 1: the method further including calculating side forces for the minimal energy shape using a continuous beam model; Element 2: the method further including Element 1 and providing a threshold value for the side forces; moving the completion string axially and rotationally through the wellbore; and changing an axial speed, a rotational speed, or both of the completion string when the side forces exceed the threshold value; Element 3: the method further including Element 1 and calculating a drag force during axial movement of the completion string through the wellbore based on the side forces for the minimal energy shape; Element 4: the method further including Element 3 and providing a threshold value for the drag force; moving the completion string axially and rotationally through the wellbore; and changing an axial speed, a rotational speed, or both of the completion string when the drag force exceeds the threshold value; Element 5: the method further including Element 1 and calculating a completion string stress for the minimal energy shape based on the side forces; Element 6: the method further including Element 5 and providing a threshold value for the completion string stress; moving the completion string axially and rotationally through the wellbore; and changing an axial speed, a rotational speed, or both of the completion string when the completion string stress exceeds the threshold value; and Element 7: wherein the portion of the wellbore changes diameter.

By way of non-limiting example, exemplary combinations applicable to Embodiments A, B, C, and D include: Elements 1-3 in combination; Elements 1-4 in combination; Elements 1, 2, and 5 in combination; Elements 1, 2, 5, and 6 in combination; Elements 1-3 and 5 in combination and optionally in further combination with one or both of Elements 4 and 6; Elements 1 and 3 in combination; Elements 1 and 3 in combination; Elements 1, 3, and 4 in combination; Elements 1 and 5 in combination; Elements 1, 5, and 6 in combination; and Element 7 in combination with one or more of Elements 1-6 including the foregoing combinations.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present invention, the following examples of preferred or representative embodiments are given. In no way should the following examples be read to limit, or to define, the scope of the invention.

### EXAMPLES

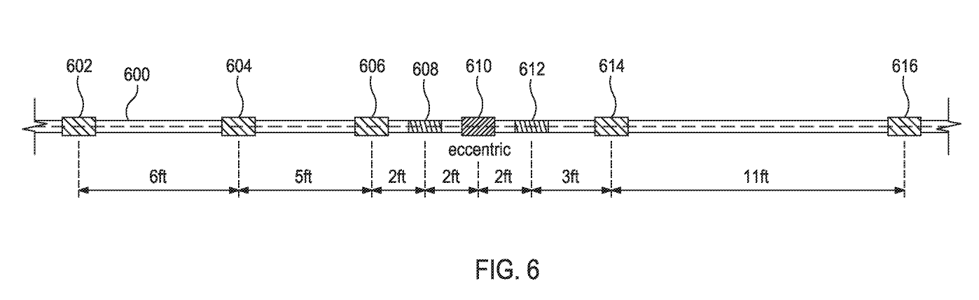

FIG. 6 illustrates a completion string 600 that was modeled and used in the following two simulated wellbore examples. The completion string 600 (3.5 inch outer diameter (OD)) has the following configuration: a first concentric tool 602 (5.7 inch OD) is spaced 6 ft from a second concentric tool 604 (5.7 inch OD), which is spaced 5 ft from a third concentric tool 606 (5.7 inch OD), which is spaced 2 ft from a fourth concentric tool 608 (variable diameter), which is spaced 2 ft from an eccentric tool 610 (5.7 inch OD), which is spaced 2 ft from a fifth concentric tool 612 (variable diameter), which is spaced 3 ft from a sixth concentric tool 614 (5.7 inch OD), which is spaced 11 ft from a seventh concentric tool 616 (5.7 inch OD). The foregoing spacings are between the centers of the respective tools. In the examples, the completion string 600 is disposed in a cased wellbore where the casing has two sections: a narrow section (6 inch inner diameter) and a large section (6.3 inch inner diameter). In the models of the following examples, the seventh concentric tool 616 is introduced (or tripped) into the narrow section first, and exact position analyzed is with the eccentric tool 610 positioned 20 ft into the narrower section of the casing.

### Example 1

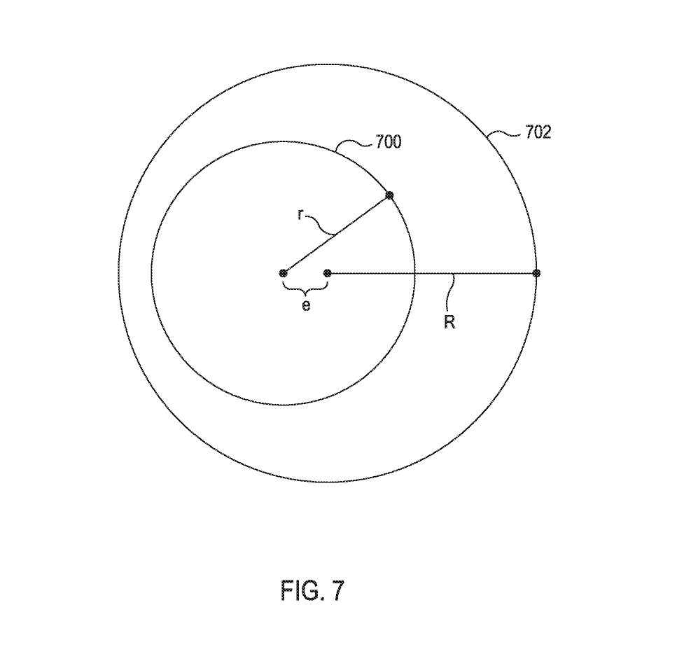

The degree of eccentricity for the eccentric tool 610 of the completion string 600 was varied from 0.5 to 0.9 in 0.1 increments. As used herein, the degree of eccentricity is defined by an eccentricity ratio that is e/R−r where, as illustrated in FIG. 7 (a cross-sectional diagram of an eccentric tool 700 in a casing 702), e is the eccentricity or length that the center of the tool 700 is away from the center of the casing 702, R is the radius of the casing 702, and r is the radius of the eccentric tool 700.

In this example, the fourth and fifth concentric tool 608,612 were modeled at 3.5 inch OD to match the completion string and considered inactive tools.

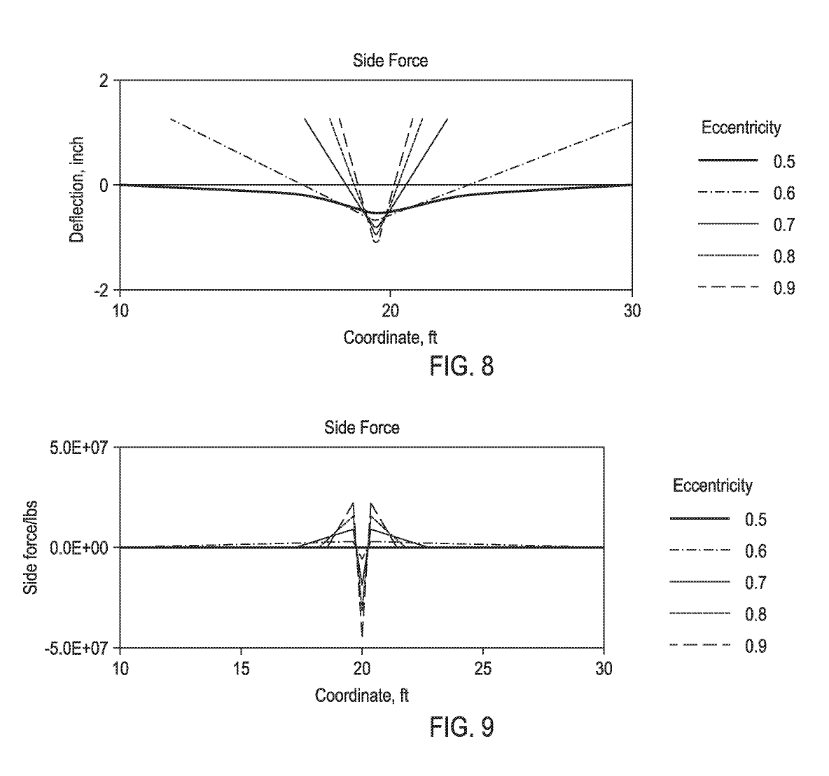

FIG. 8, with continued reference to FIG. 6, shows deformation curves of the completion string 600 at the eccentric tool 610 when the eccentricity varies. These curves suggest that when the eccentricity of the eccentric tool 610 in the middle increases, deformation of the completion string 600 becomes more extensive. Accordingly, the tools 602-606,610,614-616 that support the completion string 600 move axially closer within the wellbore. On the contrary, if the eccentricity decreases, the curve flattens, and axial distance along the wellbore between tools 602-606,610,614-616 is enlarged.

FIG. 9, with continued reference to FIG. 6, shows the plot for side forces on components for different eccentricity cases of Example 1. As the eccentricity of the eccentric tool 610 increases, the side forces on tools 602-606,610,614-16 strongly increase. This plot also suggests that the side forces are larger for the eccentric tool 610 and the third and sixth concentric tool 606,614 (i.e., the active tools closest to the eccentric tool 610) as compared to the other tools 602-604,616 that are further from the eccentric tool 610. This suggests that deformation energy of the completion string 600 will concentrate near the eccentric tool 610, and also most of side forces, drag forces, and stresses are on components and portions of the completion string 600 near the eccentric tool 610. Therefore, in many instances the 5-concentric tool analysis described herein can reach a good precision because the middle 6 components, including the eccentric tool, account for most of the side forces, drag forces, and stresses.

### Example 2

In this example, the fourth and fifth concentric tools 608,612 were modeled with variable ODs from 3.5 inches to 5.5 inches and the eccentric tool 610 having an 0.5 degree of eccentricity.

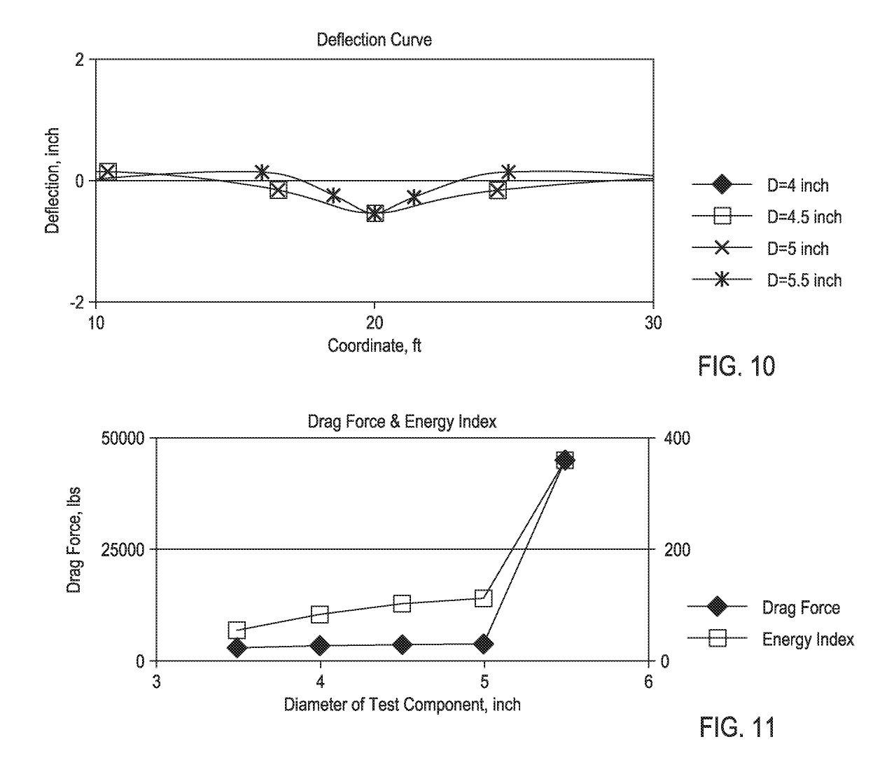

FIG. 10, with continued reference to FIG. 6, shows deflection curves of the completion string 600 at the eccentric tool 610 when the OD of the fourth and fifth concentric tools 608,612 is varied. FIG. 7 illustrates that for 5 inch or less OD of the fourth and fifth concentric tools 608,612, the deflected completion string 600 shape is more flat, and there are no support points at locations of test components. In these cases, the fourth and fifth concentric tools 608,612 are inactive components. When the OD of the fourth and fifth concentric tools 608,612 are more than 5.5 inch, the deflected completion string 600 turns steeply up, and the contact points between the fourth and fifth concentric tools 608,612 and the wellbore move axially closer within the wellbore toward the eccentric component.

FIG. 11, with continued reference to FIG. 6, shows the corresponding drag force and energy index for the completion string 600. This analysis illustrates that the greater OD (specifically 5.5 inches or greater) of the fourth and fifth concentric tools 608,612 leads to more deformation energy being stored in the completion string 600, which results in more drag force. This plot illustrates that, when deformation energy of the string increases, the drag force also increases.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A method comprising:
introducing a completion string into a wellbore, wherein a portion of the wellbore is lined with one or more casings and a portion of the completion string that resides in the portion of the wellbore has one or more tools coupled thereto according to one of: (A) wherein the one or more tools includes one or more concentric tools and one or more eccentric tools and wherein the portion of the wellbore is not deviated; (B) wherein the one or more tools includes two or more eccentric tools and wherein the portion of the wellbore is not deviated; or (C) wherein the one or more tools includes (1) one or more concentric tools, (2) one or more eccentric tools, or both (1) and (2) and wherein the portion of the wellbore is deviated;
calculating a plurality of shapes for the completion string where at least one of the one or more tools and optionally a portion of the completion string engage a casing of the one or more casings;
calculating a deformation energy of at least some of the plurality of shapes; and
selecting a minimal energy shape having a lowest deformation energy from the at least some of the plurality of shapes.

2. The method of claim 1 further comprising:
calculating side forces for the minimal energy shape using a continuous beam model.

3. The method of claim 2 further comprising:
providing a threshold value for the side forces;
moving the completion string axially and rotationally through the wellbore; and
changing an axial speed, a rotational speed, or both of the completion string when the side forces exceed the threshold value.

4. The method of claim 2 further comprising:
calculating a drag force during axial movement of the completion string through the wellbore based on the side forces for the minimal energy shape.

5. The method of claim 4 further comprising:
providing a threshold value for the drag force;
moving the completion string axially and rotationally through the wellbore; and
changing an axial speed, a rotational speed, or both of the completion string when the drag force exceeds the threshold value.

6. The method of claim 2 further comprising:
calculating a completion string stress for the minimal energy shape based on the side forces.

7. The method of claim 6 further comprising:
providing a threshold value for the completion string stress;
moving the completion string axially and rotationally through the wellbore; and
changing an axial speed, a rotational speed, or both of the completion string when the completion string stress exceeds the threshold value.

8. The method of claim 1, wherein the portion of the wellbore changes diameter.

9. A method comprising:
simulating with a mathematical model a completion string disposed in a wellbore, wherein a portion of the wellbore is lined with one or more casings and a portion of the completion string that resides in the portion of the wellbore has one or more tools coupled thereto according to one of: (A) wherein the one or more tools includes one or more concentric tools and one or more eccentric tools and wherein the portion of the wellbore is not deviated; (B) wherein the one or more tools includes two or more eccentric tools and wherein the portion of the wellbore is not deviated; or (C) wherein the one or more tools includes (1) one or more concentric tools, (2) one or more eccentric tools, or both (1) and (2) and wherein the portion of the wellbore is deviated, wherein the mathematical model is stored in a non-transitory medium readable by a processor for execution by the processor;
simulating movement of the completion string axially and rotationally through the wellbore; and
calculating a plurality of shapes for the completion string where the eccentric tool and optionally a portion of the completion string engage a casing of the one or more casings;
calculating a deformation energy of at least some of the plurality of shapes; and
selecting a minimal energy shape having a lowest deformation energy from the at least some of the plurality of shapes.

10. The method of claim 9 further comprising:
calculating side forces for the minimal energy shape using a continuous beam model.

11. The method of claim 10 further comprising:
providing a threshold value for the side forces;
moving the completion string axially and rotationally through the wellbore; and
changing an axial speed, a rotational speed, or both of the completion string when the side forces exceed the threshold value.

12. The method of claim 10 further comprising:
calculating a drag force during axial movement of the completion string through the wellbore based on the side forces for the minimal energy shape.

13. The method of claim 12 further comprising:
providing a threshold value for the drag force;
moving the completion string axially and rotationally through the wellbore; and
changing an axial speed, a rotational speed, or both of the completion string when the drag force exceeds the threshold value.

14. The method of claim 10 further comprising:
calculating a completion string stress for the minimal energy shape based on the side forces.

15. The method of claim 9, wherein the portion of the wellbore changes diameter.

16. (canceled)

17. A non-transitory medium readable by a processor and storing instructions for execution by the processor for performing a method comprising:
receiving a plurality of inputs relating to a configuration of a system that comprises a completion string extending into a wellbore, wherein a portion of the wellbore is lined with one or more casings and a portion of the completion string that resides in the portion of the wellbore has one or more tools coupled thereto according to one of: (A) wherein the one or more tools includes one or more concentric tools and one or more eccentric tools and wherein the portion of the wellbore is not deviated; (B) wherein the one or more tools includes two or more eccentric tools and wherein the portion of the wellbore is not deviated; or (C) wherein the one or more tools includes (1) one or more concentric tools, (2) one or more eccentric tools, or both (1) and (2) and wherein the portion of the wellbore is deviated;
calculating a plurality of shapes for the completion string where the eccentric tool and optionally a portion of the completion string engage a casing of the one or more casings;
calculating a deformation energy of at least some of the plurality of shapes; and
selecting a minimal energy shape having a lowest deformation energy from the at least some of the plurality of shapes.
